(19) United States
(12) Patent Application Publication
(10) Pub. No.: US 2024/0193403 A1
(43) Pub. Date: Jun. 13, 2024

(54) APPARATUS AND METHOD FOR CALIBRATING PREDICTION MODELS

(71) Applicant: SAMSUNG SDS CO., LTD., Seoul (KR)

(72) Inventors: Sukhoon JUNG, Seoul (KR); Lion ALIO, Seoul (KR); Sungyoon KIM, Seoul (KR); Vu Dinh HINH, Seoul (KR); Kihyo MOON, Seoul (KR)

(73) Assignee: SAMSUNG SDS CO., LTD., Seoul (KR)

(21) Appl. No.: 18/370,529

(22) Filed: Sep. 20, 2023

(30) Foreign Application Priority Data
Dec. 13, 2022 (KR) 10-2022-0173881

(51) Int. Cl. G06N 3/0455; G06N 3/08

(52) U.S. Cl. CPC G06N 3/0455; G06N 3/08

(57) ABSTRACT

An apparatus for calibrating prediction models of an inference service, including a computer program and a processor for executing the computer program according to an example embodiment of the present disclosure, wherein the apparatus includes: a drift pattern creating unit configured to detect a latent factor of learning data and create a possible drift pattern for the learning data based on the detected latent factor; and an instruction executing an individual drift calibrating unit configured to pre-learn calibration information according to a loss function between the learning data and the drift pattern for each drift pattern, and an ensemble drift calibrating unit including a similarity determining unit configured to perform prelearning to determine similarity between recovery data recovered by reconstructing the input drift pattern and the drift pattern.

### CROSS-REFERENCE TO RELATED APPLICATION (S)

This application claims benefit of priority to Korean Patent Application No. 10-2022-0173881 filed on Dec. 13, 2022, in the Korean Intellectual Property Office, the disclosure of which is incorporated herein by reference in its entirety.

### BACKGROUND

### 1. Field

The present disclosure relates to an apparatus and method for calibrating prediction models of an inference service, and more particularly, to an apparatus and method for calibrating prediction models of an inference service that calibrates input data without replacing or relearning prediction models when input data drift occurs.

### 2. Description of Related Art

Recently, AI services are becoming more common due to big data accumulation and cloud environment development, and machine learning (e.g., Machine Learning (ML)/Deep Learning (DL)) algorithms. Especially with the advent of AI platforms and MLOps platforms provided by large cloud companies, ML modeling and learning, and an operation of inference services based thereon are becoming easier, thus accelerating the emergence of various AI services.

Most AI services are concerned about a decrease in service accuracy due to data drift. Data drift denotes a phenomenon in which, during learning of an AI model such as ML/DL, the statistical distribution of the input data is different due to some changes after the statistical distribution of the input data (Feature) and the distribution for the service. Typical examples of data drift may include a change in a feature due to changes in customer taste and purchasing power in product recommendation services, a change in a sensor measurement value due to changes in the surrounding environment in an IoT service, and image quality deterioration due to camera lens contamination in the detection of defective products in a production line. These changes may inevitably cause a decrease in the accuracy of AI services.

Data drift may occur step by step or gradually in any instrument after service distribution. Furthermore, the changes tend to gradually accumulate, which may further decrease service accuracy over time. To respond thereto, a service operator may restore the service accuracy by redesigning a service model regularly and/or irregularly, or by relearning the existing model by obtaining new data reflecting the data drift. For the convenience of this process, AI platforms and MLOps platforms also provide tools for monitoring and detecting data drift and tools for automating relearning/redistribution.

In conventional patent documents, in order to relearn a prediction model using inference data before a replacement cycle of the prediction model arrives, a relearned model may be further learned in addition to a prediction model for providing a service, and then, through performance comparison, the prediction model may be replaced with the relearned model.

However, new learning data reflecting drift may be required in order to redesign or relearn a service model, labels of each data sample may be tagged through an expert's inspection to obtain appropriate new learning data, an automation process of accumulating data samples in which the labels are tagged needs to be built, and additional data science tasks such as verification and post-processing of accumulated data may be required, thereby consuming a large amount of labor, costs, and time.

Furthermore, a redistribution process also requires additional costs in terms of verification and operation because the relearned model is serviced through a redistribution procedure using new data obtained manually or automatically.

An additional process for the relearning/redistribution may inevitably result in a problem of delayed response to the data drift.

(Patent Document 1) KR 10-2022-0049165 A (Apr. 21, 2022)

### SUMMARY

In order to solve the conventional problem, an aspect of the present disclosure is to provide an apparatus and method for calibrating prediction models of an inference service, which may create a possible drift pattern for input data in a learning phase of a prediction model and pre-learn calibration information, and calibrate input data drift after service distribution without replacing or relearning a separate prediction model.

According to an aspect of the present disclosure, provided is an apparatus for calibrating prediction models of an inference service, including a computer program and a processor for executing the computer program, wherein the apparatus for calibrating prediction models of an inference service includes: a drift pattern creating unit configured to detect a latent factor of learning data and create a possible drift pattern for the learning data based on the detected latent factor; and an instruction executing an individual drift calibrating unit configured to pre-learn calibration information according to a loss function between the learning data and the drift pattern for each drift pattern, and an ensemble drift calibrating unit including a similarity determining unit configured to perform prelearning to determine similarity between recovery data recovered by reconstructing the input drift pattern and the drift pattern, wherein the individual drift calibrating units are connected in parallel, and the similarity determining units are connected in parallel to the individual drift calibrating units, respectively.

According to another aspect of the present disclosure, provided is a method for calibrating prediction models of an inference service, performed on a computing device comprising: a processor; and a computer-readable storage medium in which a computer program executed by the processor is stored, wherein the program includes: detecting a latent factor of learning data and creating a possible drift pattern for the learning data based on the detected latent factor; prelearning calibration information according to a loss function between the learning data and the drift pattern for each drift pattern and outputting the calibration information for input data; and determining similarity between the input data and recovery data by performing prelearning in order to determine similarity between the recovery data recovered by reconstructing the input drift pattern and the drift pattern, wherein final calibration information is applied to the input data by integrating the calibration information output independently for each drift pattern.

According to an example embodiment of the present disclosure, an existing input prediction model may be utilized unchangeably without the need to replace or relearn a separate prediction model, such as replacing an existing prediction model with a new model or relearning with new data, thereby avoiding reduced prediction accuracy as well as saving time and costs with quick and continuous response.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 illustrates a step-by-step process for supplying a prediction model as a service;

FIG. 2 is an example embodiment in which an apparatus for calibrating prediction models according to an example embodiment of the present disclosure is applied to a prediction model;

FIGS. 3A and 3B are a block diagram illustrating an apparatus for calibrating prediction models according to an example embodiment of the present disclosure;

FIG. 4 is a view schematically illustrating an operating principle of a drift pattern creating unit according to an example embodiment of the present disclosure;

FIG. 5 is a conceptual diagram illustrating a VAE-based generative model of a drift pattern creating unit according to an example embodiment of the present disclosure;

FIG. 6 is a block diagram illustrating an individual drift calibrating unit and a similarity determining unit according to an example embodiment of the present disclosure;

FIG. 7 is a block diagram of an ensemble drift calibrating unit according to an example embodiment of the present disclosure;

FIG. 8 illustrates an algorithm of an ensemble drift calibrating unit according to an example embodiment of the present disclosure;

FIG. 9 illustrates a flowchart of a method for calibrating prediction models according to an example embodiment of the present disclosure; and

FIG. 10 illustrates a computing device according to an example embodiment of the present disclosure.

### DETAILED DESCRIPTION

Hereinafter, a specific embodiment of the present disclosure will be described with reference to the drawings. The following detailed description is provided to help gain a comprehensive understanding of methods, apparatuses, and/or systems described herein. However, this is only an example, and the present disclosure is not limited thereto.

In describing example embodiments of the present disclosure in detail, when it is determined that a detailed description of known technologies associated with the present disclosure may unnecessarily obscure the gist of the present disclosure, the detailed description thereof will be omitted. Furthermore, the terms described below are defined in consideration of functions in the present disclosure, and may vary according to the intention or practice of a user or an operator. Therefore, the definition thereof should be based on the content throughout this specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a portion or combinations thereof, and shall not be construed to preclude any presence or possibility of one or more other characteristics, numbers, steps, operations, elements, parts or combinations thereof.

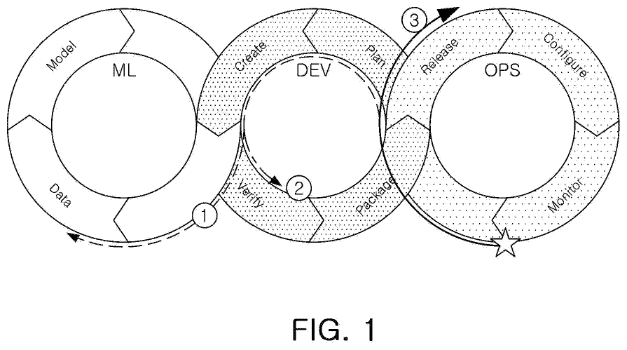

FIG. 1 illustrates a step-by-step process for supplying a prediction model as a service.

As illustrated in FIG. 1, data preparation and prediction model generation (ML) from an MLOps perspective, prediction model validation and prediction service development (DEV), and a service operation stage (OPS) including service distribution and monitoring is performed in order to infer prediction data according to input data in an inference service system by a prediction model (ML model) calibration apparatus according to an example embodiment of the present disclosure.

In order to prevent an occurrence of data drift, there are a method for calibrating prediction models by collecting new data during a data preparation operation (model calibration), or a method for relearning prediction models in a prediction model verification operation (relearning), and a method for supplying calibrated input data to prediction models by calibrating input data in which data drift has occurred in a service operation phase (data correction).

However, since model calibrating and relearning methods require up-to-date labeled data, they must perform again a data collection and labeling process, and a prediction model verification process, which may cause response speed to data drift to be slow and it may be difficult to provide continuous inference services.

Accordingly, an apparatus for calibrating prediction models according to an example embodiment of the present disclosure may calibrate input data in which data drift occurs during a prediction model distribution and monitoring operation in order to prevent a decrease in prediction accuracy while using an existing prediction model unchangeably, and does not require the latest labeled data, data accumulation, relearning, and a prediction model verification process, thereby enabling agile and continuous response to data drift.

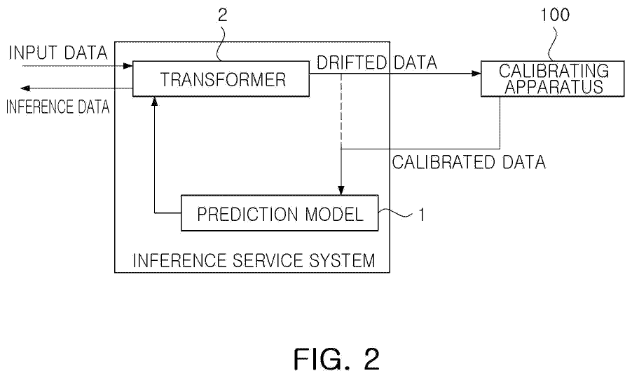

FIG. 2 is an example embodiment in which an apparatus 100 for calibrating prediction models is applied to a prediction model 1 of an inference service system, and as illustrated in FIG. 2, input data is subject to pre-processing of data by passing through Transformer 2, and when the input data is drifted data, the inference service system may obtain calibrated data through the apparatus 100 for calibrating prediction models and supply the calibrated data to the prediction model 1.

The prediction model 1 may output inference data by analyzing d data with the same statistical distribution as learning data by removing data drift, and provide the inference data through transformer 2.

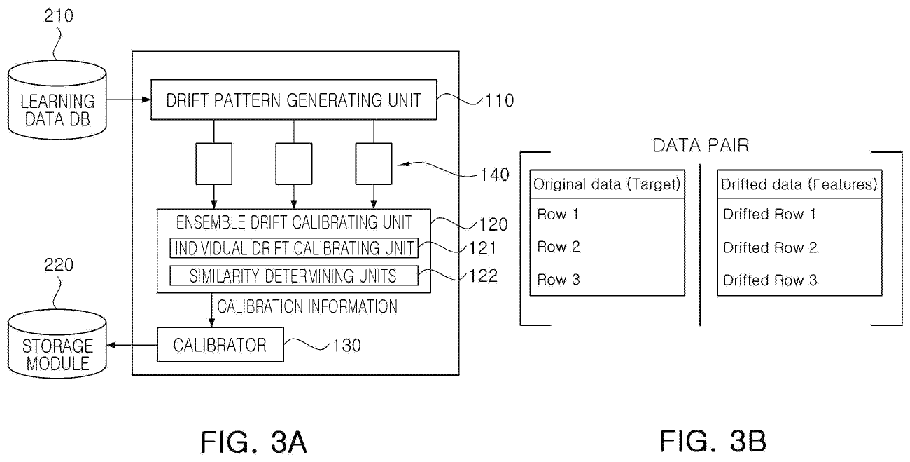

Hereinafter, an exemplary diagram illustrating the apparatus for calibrating prediction models 100 according to an example embodiment will be described with reference to FIGS. 3 to 9.

The apparatus 100 for calibrating prediction models of an inference service may be performed in a computing device including a computer program and a processor executing the computer program.

As described in FIG. 3A, the apparatus 100 for calibrating prediction models of an inference service according to an example embodiment of the present disclosure may include a drift pattern creating unit 110 for detecting a latent factor of learning data and creating a possible drift pattern for the learning data based on the detected latent factor, an individual drift calibrating unit 121 for prelearning calibration information according to a loss function between the learning data and the drift pattern for each drift pattern, and an ensemble drift calibrating unit 120 including a similarity determining unit 122 for performing prelearning so as to determine similarity between the drift pattern and the recovered recovery data by reconstructing the input drift pattern.

Furthermore, the ensemble drift calibrating unit 120 according to an example embodiment of the present disclosure may include a plurality of individual drift calibrating units 121 and similarity determining units 122, the individual drift calibrating units 121 may be connected to each other in parallel, and the similarity determining units 122 may be connected in parallel to the individual drift calibrating units 121, respectively. FIG. 3A illustrates only one individual drift calibrating unit 121 and a similarity determining unit 122 connected thereto, but the ensemble drift calibrating unit 120 may include a plurality of individual drift calibrating units 121 and similarity determining units 122 connected thereto.

According to an example embodiment, when a prediction model learns using learning data stored in the learning data DB 210 in a prediction model generation operation, the drift pattern creating unit 110 of the apparatus 100 for calibrating prediction models may create a possible drift pattern using the learning data stored in the prediction model learning data DB 210.

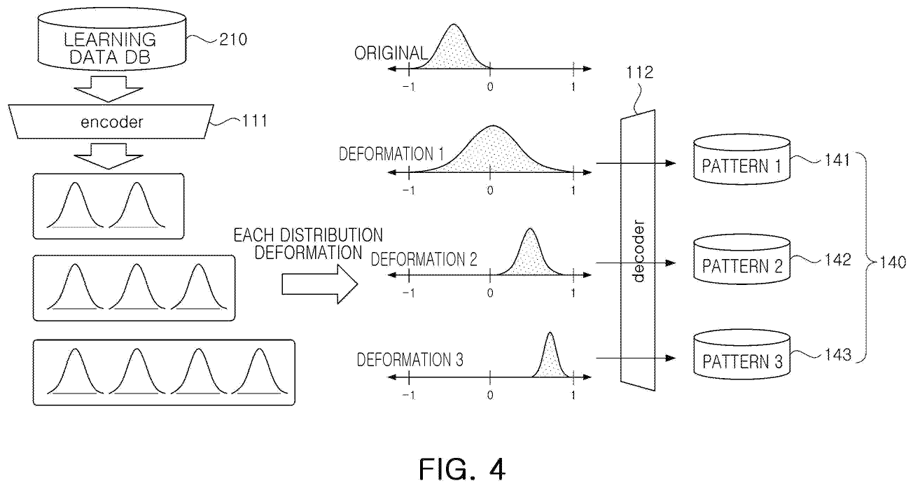

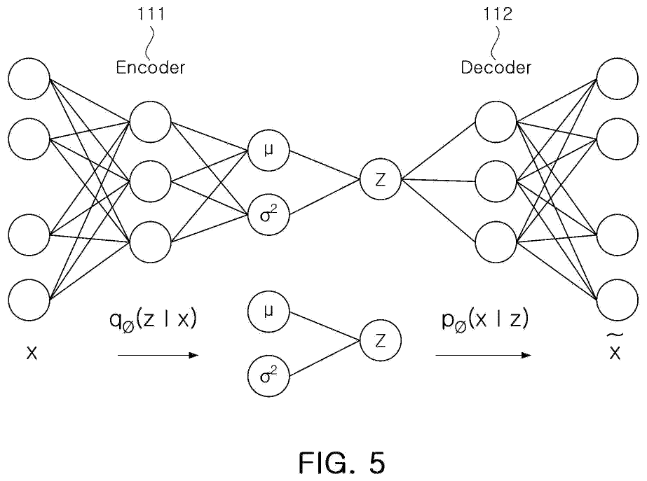

As described in FIGS. 4 and 5, the drift pattern creating unit 110 according to an example embodiment of the present disclosure may estimate a plurality of latent factors from the learning data using a variational auto encoder (VAE)—based generative model and create a drift pattern by changing a covariate between the estimated latent factors for input noise data.

In an example embodiment, the VAE-based generative model may include an encoder 111 and a decoder 112, and the encoder 111 may encode learning data to estimate latent factors for explaining the learning data, and the decoder 112 may decode the estimated latent factors to create a drift pattern that may occur when the latent factors change.

As an example embodiment, the latent factor may represent a statistical distribution of learning data, and as illustrated in FIG. 5, the latent factor may be represented by standard deviation (p) and variance (σ²). σ²

As an example embodiment, the decoder 112 may output a possible drift pattern (σ²) when a drift error occurs in a latent factor that will explain the learning data by changing the covariate between the latent factors in consideration of a correlation (z) between the latent factors with the standard deviation (μ) and variance (σ²) output by the encoder 111. In this case, the drift error may reflect various types of deformation, such as deformation 1 in which data distribution is widely spread, deformation 2 in which data is shifted, and deformation 3 in which data is shifted and narrowed sharper, or a degree of the deformation.

The latent factor may be at least one latent factor, and as another example embodiment, a VAE-based generative model may be prelearned so that two or more latent factors are output.

As an example embodiment, the drift pattern creating unit 110 may include a plurality of VAEs that for estimating different numbers of latent factors. For example, when three VAEs are included therein, a first VAE may create a drift pattern based on two latent factors, a second VAE may create a drift pattern based on three latent factors, and a third VAE may create a drift pattern based on four latent factors. Various patterns may be created by changing the number of latent factors.

Although the encoder 111 and the decoder 112 are illustrated as one in FIG. 4, a plurality of encoders 111 may be used depending on the number of latent factors to be output or the degree of deformation, and a plurality of encoders 112 may be used so that each of the decoders 112 corresponds according to latent factors output from each of the encoders 111.

Furthermore, as an example embodiment, a possible pattern can be created in consideration of the number of latent factors, the type of deformation or the degree of deformation, and in this case, each VAE-based generative model may be independently driven depending on the number of latent factors, the type of deformation or degree of deformation, and each pattern created by the decoder 112 of each VAE-based generative model may be divided into pattern n such as pattern 1 (141), pattern 2 (142) and pattern 3 (143) and then stored.

As illustrated in FIG. 3A and FIG. 4, there may be further provided a drift pattern classifying unit 140 for classifying a data pair including the learning data and the corresponding drift pattern according to a drift level. The drift level may be determined using a rooted mean squared error (RMSE) of the data pair.

The pattern classifying unit 140 may include a pattern classifying unit 1 (141) in which pattern 1 is stored, a pattern classifying unit 2 (142) in which pattern 2 is stored, and a pattern classifying unit 3 (143) in which pattern 3 is stored, and the number thereof is not fixed.

By regarding, as a label, the learning data that is original data, calibration information may be obtained using a difference from drift data as the input data according to a loss function, and for this purpose, the original data, that is, leaning data Row1, Row2 and Row3 may be matched with drift patterns Drifted Row1, Drifted Row2, and Drifted Row3, and may be stored as a data pair.

Depending on the drift level, each data pair may be may be divided into a pattern classifying unit 1(141), a pattern classifying unit 2 (142), and a pattern classifying unit 3 (143), which are included in the drift pattern classification units 140, an RMSE average of all data pairs in a specific drift pattern classifying unit 140 is set to a drift level of the corresponding pattern, and when the RMSE average of a specific data pair matches the drift level in the specific drift pattern classifying unit 140, the specific data pair may be classified into a specific drift pattern classifying unit 140.

The individual drift calibrating unit 12 described below may apply prelearned calibration information to the corresponding drift pattern by calculating the degree to which the input data matches the drift pattern that is most likely to have occurred among the drift patterns classified in the drift pattern classifying unit 140.

As an example embodiment, a merged data pair may be used for prelearning by merging an entire data pair stored in each drift pattern classifying unit 140.

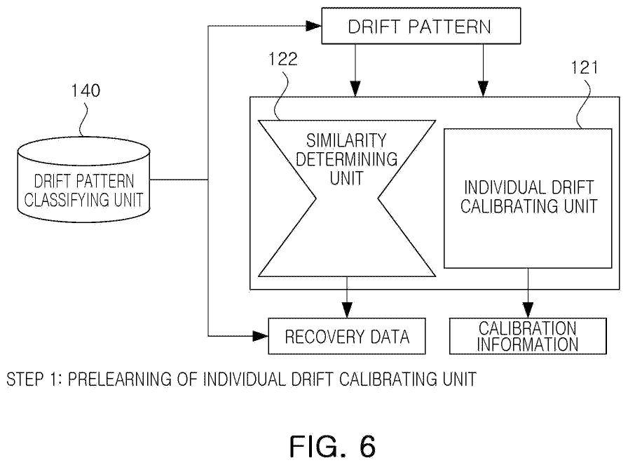

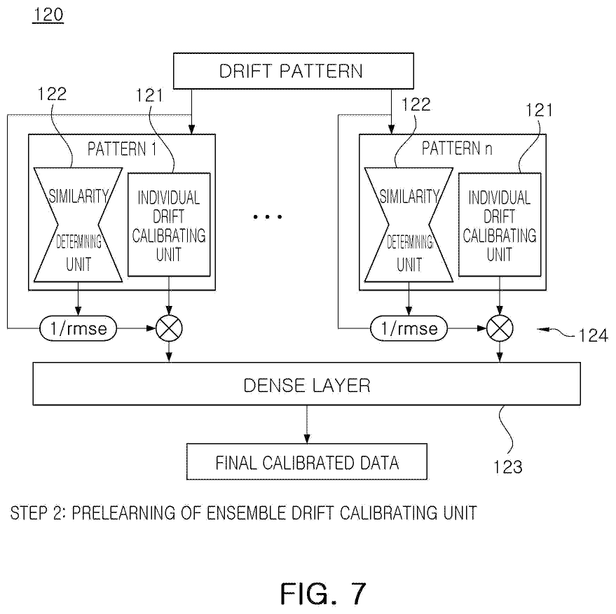

As illustrated in FIGS. 6 and 7, the ensemble drift calibrating unit 120 may include each individual drift calibrating unit 121 for independently performing prelearning using the data pairs classified in each drift pattern classifying unit 140.

As an example embodiment, the drift pattern classifying unit 140 may store a drift pattern with a corresponding drift level, and may transmit the stored drift pattern to the corresponding individual drift calibrating unit 121 and the corresponding similarity determining unit 122.

When the drift pattern is input, the individual drift calibrating unit 121 may output calibration information according to a loss function by regarding learning data matched with the drift pattern through the data pair as a label.

When the drift pattern is input, the similarity determining unit 122 may estimate a latent factor capable of explaining the drift pattern, and may output recovery data reconstructed based on the estimated latent factor, thereby determining the similarity between the recovery data and the input drift pattern.

As an example embodiment, the similarity determining unit 122 may be a VAE-based generative model for more similarly reconstructing input data having the same data distribution as the prelearned learning data.

When the latent element estimated by the similarity determining unit 122 is a latent element that can accurately explain the drift data created in the drift pattern, the similarity between the recovery data and the drift pattern is very high.

Accordingly, as Step 1, an individual drift calibrating unit 121 and a similarity determining unit 122 corresponding to each drift pattern may perform prelearning.

As an example embodiment, the similarity determining unit 122 may determine the similarity between input data input during service and recovery data recovered by reconstructing the input data, and adjust a weight of the individual drift calibrating unit 121 according to the determined similarity.

Through this, it may be indirectly determined how much input data matches the drift pattern, and by increasing a weight of the individual drift calibrating unit 121 corresponding to the similarity determination unit 122 having a high similarity due to a high matching rate, it may be possible to further increase a ratio of calibration information of the individual drift calibrating unit 121 prelearned to have high similarity.

The drift patterns stored in each drift classifying unit 140 may not be completely separate drift patterns from each other, but may be drift patterns with data overlapping each other to a certain extent. In this case, the similarity of the input data may be determined for drift patterns having each overlapping data, and final calibration information may be obtained by changing the weight of the calibration information according to the similarity.

As illustrated in FIG. 7, the ensemble drift calibrating unit 120 may further include a dense layer 123 for applying the weight to the calibration information of the individual drift calibrating unit 121 to sum up the final calibration information to be applied to the input data.

As an example embodiment, calibration information may be output from each of a prelearned similarity determining unit 122 and a prelearned individual drift calibrating unit 121 from pattern 1 to pattern n, and after 1/RMSE is applied to the calibration information and the calibration information are summed up (a weight adjusting unit 124), weighted calibration information may be integrated. Then, the integrated calibration information may be transmitted to the dense layer 123 to calculate final calibrated data.

Accordingly, as Step 2, the ensemble drift calibrating unit 120 having an ensemble structure by integrating the individual drift calibrating unit 121 and the similarity determining unit 122 corresponding to each prelearned drift pattern may be learned based on data obtained by incorporating all drift patterns.

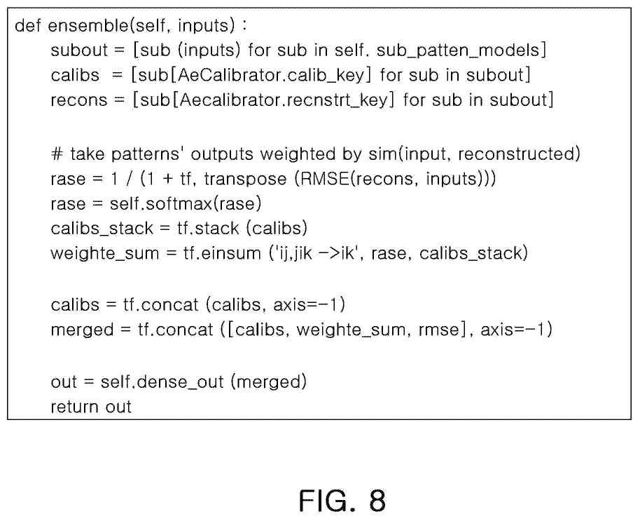

FIG. 8 illustrates an algorithm for calibrating and integrating corresponding drift patterns in input data according to a weight according to each operation performed by an ensemble drift calibrating unit 120.

Meanwhile, there may be further provided a storage module 220 (see FIG. 3) for storing a prelearned ensemble drift calibrating unit 120 until abnormality in input data is detected.

As an embodiment, training data stored in training data DB 210 may be provided to a VAE-based generative model that operates independently depending on the number of latent factors or the type or degree of deformation, and each drift pattern output from the independently operated VAE-based generative model may be stored in a corresponding drift pattern classifying unit 140.

Furthermore, the drift pattern stored in the drift pattern classifying unit 140 may be transmitted to the corresponding similarity determining unit 122 and the corresponding individual drift calibrating unit 121, and after 1/RMSE is applied to the calibration information respectively output from the individual drift calibrating unit 121 and the calibration information is summed up (the weight adjusting unit 124), the calibration information may be output as final corrected data. Then final calibrated data may be stored in the storage module 220.

According to an example embodiment, the storage module 220 may store the calibration information unchangeably, and according to another example embodiment, when the final calibration information passes through a calibrator 130 to output the calibrated data, the final calibration data may be integrated and stored.

The apparatus 100 for calibrating prediction models according to an example embodiment of the present disclosure showed a result in which when accuracy is reduced due to data drift, 7 to 23% of the reduced accuracy is recovered, through which it was found that specifically, as the accuracy is reduced, a calibration rate tends to increase. For example, for the NOAA weather forecast, two classes were set for the next-day precipitation prediction, and 3, 650 data from the past 10 years were learned as learning data, and then, as a result of performing the weather forecast for the last 40 years, when only the individual drift calibrating unit 121 was used, an entire recovery rate was 1%, and a calibration rate was 13% when the accuracy was reduced by 15% or more; however, when the ensemble drift calibrating unit 120 was used, the entire recovery rate was 11%, and the calibration rate was 23% when the accuracy was reduced by 15% or more.

Accordingly, since the structure using the ensemble drift calibrating unit 120 may calibrate the data drift in the operation of providing the service, it does not require a separate labeling process or relearning, and since the drift data may be calibrated with only service model learning data input by the user without relearning and redistribution procedures, the data drift calibration may be generalized and automated.

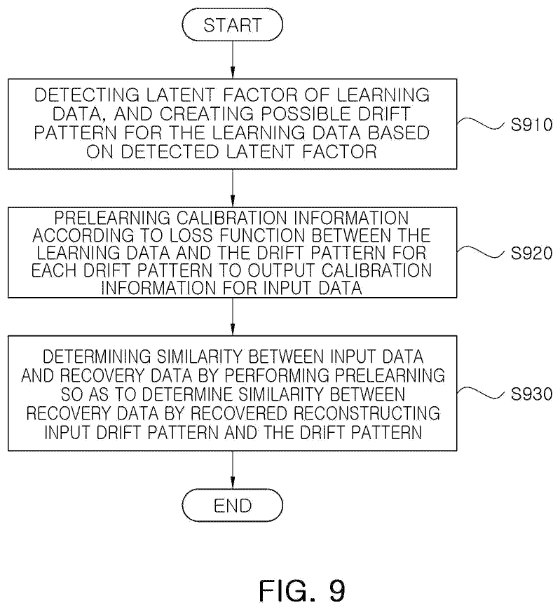

As illustrated in FIG. 9, a method for calibrating prediction models according to an example embodiment of the present disclosure may include detecting a latent factor of learning data and creating a possible drift pattern for the learning data based on the detected latent factor (S910), prelearning calibration information according to a loss function between the learning data and the drift pattern for each drift pattern to output calibration information for input data (S920), and determining the similarity between input data and recovery data by performing prelearning so as to determine the similarity between the recovery data by recovered reconstructing the input drift pattern and the drift pattern (S930).

Furthermore, as an example embodiment, final calibration information may be applied to the input data by integrating the calibration information output independently for each drift pattern.

The operation S910 of creating the possible drift pattern may include estimating a plurality of latent factors from the learning data using a variable auto encoder (VAE)—based generative model, and creating a drift pattern by changing a covariate between the estimated latent factors for input noise data.

The VAE-based generative model may learn the network by itself by obtaining a latent factor z from input data x as original data, which allows for the use of input data as a label without the need for separate labels.

As an example embodiment, the VAE-based generative model may include a plurality of VAEs that estimate a different number of latent factors.

The method for calibrating prediction models according to an example embodiment of the present disclosure further includes classifying a data pair including the learning data and the corresponding drift pattern according to a drift level, and the drift level may be determined using a rooted mean squared error (RMSE) of the data pair.

The operation of outputting the calibration information and the operation of determining the similarity between the input data and the recovery data (S930) may include an operation of determining the similarity between input data input during service and recovery data recovered by reconstructing the input data and adjust a weight to be applied to the calibration information output independently for each drift pattern according to the determined similarity, and an operation of applying final calibration information to the input data by integrating the calibration information for each drift pattern to which the weight is applied.

Furthermore, the operation of determining the similarity between the input data and the recovery data (S930) may include reconstructing input data having the same data distribution as the prelearned learning data more similarly using the VAE-based generative model. A description overlapping the aforementioned description will be omitted to avoid repeating the description.

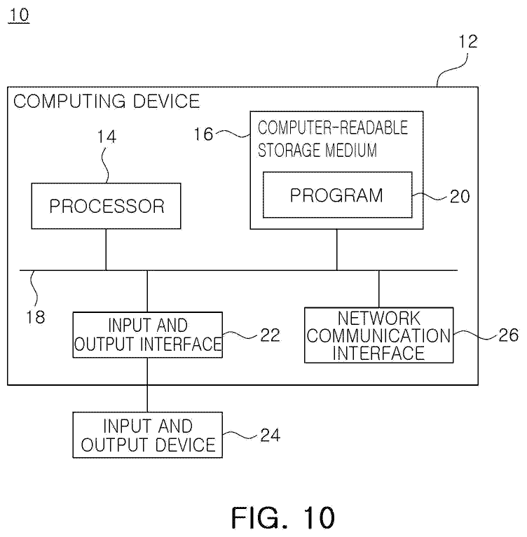

FIG. 10 is a block diagram illustrating a computing environment including a computing device according to an example embodiment of the present disclosure. In the illustrated embodiment, each component may have different functions and capabilities in addition to those described below, and may include additional components in addition to those described below.

A computing environment 10 described in FIG. 10 includes a computing device 12, and the computing device 12 may include a computer-readable storage medium configured to record a computer program executed to implement the above-described method for calibrating prediction models on a computer.

A computing device 12 includes at least one processor 14, a computer-readable storage medium 16, and a communication bus 18. The processor 14 may cause the computing device 12 to operate according to the aforementioned example embodiment. For example, the processor 14 may execute one or more programs stored in the computer-readable storage medium 16. The one or more programs may include one or more computer executable instructions, and when the computer executable instructions are executed by the processor 14, the computing device 12 may be configured to perform operations according to an example embodiment.

The computer-readable storage medium 16 are configured to store computer-executable instructions or program codes, program data, and/or other suitable forms of information. A program 20 stored in the computer-readable storage medium 16 includes a set of instructions executable by the processor 14. In an example embodiment, the computer-readable storage medium 16 may be a memory (a volatile memory such as a random access memory, a nonvolatile memory, or an appropriate combination thereof), one or more magnetic disk storage devices, optical disk storage devices, flash memory devices, other types of storage media that can be accessed by computing device 12 and store desired information, or a suitable combination thereof.

The communication bus 18 interconnects various other components of the computing device 12, including the processor 14 and the computer-readable storage medium 16.

The computing device 12 may also include one or more input/output interfaces 22 and one or more network communication interfaces 26 that provide an interface for one or more input/output devices 24. The input/output interface 22 and the network communication interface 26 are connected to the communication bus 18. The input/output device 24 may be connected to other components of the computing device 12 through the input/output interface 22. Exemplary input and output devices may include input devices such as pointing devices (a mouse or a trackpad), keyboards, touch input devices (a touchpad or a touchscreen), voice or sound input devices, various types of sensor devices and/or capturing devices, and/or output devices such as display devices, printers, speakers, and/or network cards. The exemplary input and output device 24 may be included in the computing device 12 as a component constituting the computing device 12, or may be connected to the computing device 12 as a separate device distinct from the computing device 12.

Although representative example embodiments of the present disclosure have been described in detail above, those skilled in the art will understand that the above-described embodiments can be modified in various ways without departing from the scope of the present disclosure. Therefore, the scope of the present disclosure should not be limited to the described example embodiment and should be determined by the claims described below as well as those equivalent to the claims.

What is claimed is:

1. An apparatus for calibrating prediction models of an inference service, including a computer program and a processor for executing the computer program, wherein the apparatus for calibrating prediction models of an inference service comprises:
a drift pattern creating unit configured to detect a latent factor of learning data and create a possible drift pattern for the learning data based on the detected latent factor; and
an instruction executing an individual drift calibrating unit configured to pre-learn calibration information according to a loss function between the learning data and the drift pattern for each drift pattern, and an ensemble drift calibrating unit including a similarity determining unit configured to perform prelearning to determine similarity between recovery data recovered by reconstructing the input drift pattern and the drift pattern,
wherein the individual drift calibrating units are connected in parallel, and the similarity determining units are connected in parallel to the individual drift calibrating units, respectively.

2. The apparatus for calibrating prediction models of an inference service according to claim 1, wherein the drift pattern creating unit is configured to,
estimate a plurality of latent factors from the learning data using a variable auto encoder (VAE)—based generative model, and
create a drift pattern by transforming a covariate between the estimated latent factors for input noise data.

3. The apparatus for calibrating prediction models of an inference service according to claim 2, wherein drift pattern creating unit includes a plurality of VAEs for estimating a different number of latent factors.

4. The apparatus for calibrating prediction models of an inference service according to claim 1, further comprising:
a drift pattern classifying unit configured to classify a data pair including the learning data and the corresponding drift pattern according to a drift level,
wherein the drift level is determined using a rooted mean squared error (RMSE) of the data pair.

5. The apparatus for calibrating prediction models of an inference service according to claim 4, wherein the ensemble drift calibrating unit comprises:
respective individual drift calibrating units configured to perform prelearning independently using the data pair classified in the respective drift pattern classifying units.

6. The apparatus for calibrating prediction models of an inference service according to claim 1, wherein the similarity determining unit determines the similarity between input data input during service and recovery data recovered by reconstructing the input data, and adjusts a weight of the individual drift calibrating unit according to the determined similarity, and
the ensemble drift calibrating unit further includes a dense layer configured to apply the weight to calibration information of the individual drift calibrating unit to sum up final calibration information to be applied to the input data.

7. The apparatus for calibrating prediction models of an inference service according to claim 6, wherein the similarity determining unit is a VAE-based generative model for more similarly reconstructing input data having the same data distribution as prelearned learning data.

8. The apparatus for calibrating prediction models of an inference service according to claim 1, further comprising:
a storage module for storing prelearned ensemble drift calibrating unit until abnormality in input data is detected.

9. A method for calibrating prediction models of an inference service, performed on a computing device comprising: a processor; and a computer-readable storage medium in which a computer program executed by the processor is stored, wherein the program comprises:
detecting a latent factor of learning data and creating a possible drift pattern for the learning data based on the detected latent factor;
prelearning calibration information according to a loss function between the learning data and the drift pattern for each drift pattern and outputting the calibration information for input data; and
determining similarity between the input data and recovery data by performing prelearning in order to determine similarity between the recovery data recovered by reconstructing the input drift pattern and the drift pattern,
wherein final calibration information is applied to the input data by integrating the calibration information output independently for each drift pattern.

10. The method for calibrating prediction models of an inference service according to claim 9, wherein the creating a possible drift pattern comprises:
estimating a plurality of latent factors from the learning data using a variational auto encoder (VAE)—based generative model; and
creating a drift pattern by changing a covariate between the estimated latent factors for input noise data.

11. The method for calibrating prediction models of an inference service according to claim 10, wherein the VAE-based generative model includes a plurality of VAEs for estimating a different number of latent factors.

12. The method for calibrating prediction models of an inference service according to claim 9, further comprising:
classifying a data pair including the learning data and the corresponding drift pattern according to a drift level,
wherein the drift level is determined using a rooted mean squared error (RMSE) of the data pair.

13. The method for calibrating prediction models of an inference service according to claim 9, wherein the outputting the calibration information and the determining similarity between the input data and recovery data comprise:
determining similarity between input data input during service and recovery data recovered by reconstructing the input data, and adjusting a weight to be applied to calibration information output independently for each drift pattern according to the determined similarity; and
applying final calibration information to the input data by integrating the calibration information for each drift pattern to which the weight is applied.

14. The method for calibrating prediction models of an inference service according to claim 13, wherein the determining similarity between input data and recovery data comprises:
more similarly reconstructing input data having the same data distribution as prelearned learning data using a VAE-based generative model.
